(19) United States
(12) Patent Application Publication
(10) Pub. No.: US 2026/0317166 A1
(43) Pub. Date: Oct. 15, 2026

(54) GAS PYROLYSIS UNIT AND GAS PYROLYSIS APPARATUS

(71) Applicant: NGK CORPORATION, Nagoya-Shi (JP)

(72) Inventors: Shuichi ICHIKAWA, Nagoya-Shi (JP); Takuya ISHIHARA, Nagoya-Shi (JP); Masato ASANO, Nagoya-Shi (JP)

(73) Assignee: NGK CORPORATION, Nagoya-Shi (JP)

(21) Appl. No.: 19/688,813

(22) Filed: May 27, 2026

Related U.S. Application Data
(63) Continuation of application No. PCT/JP2024/041520, filed on Nov. 22, 2024.

(30) Foreign Application Priority Data
Dec. 8, 2023 (JP) 2023-207977

(51) Int. Cl. C01B 3/26

(52) U.S. Cl. CPC C01B 3/26; C01B 2203/0277; C01B 2203/1023; C01B 2203/1235

(57) ABSTRACT

The gas pyrolysis unit 2 according to the present invention includes: a honeycomb structure 20 having one or more honeycomb structure portions 24, each of the one or more honeycomb structure portions 24 having an outer peripheral wall 240 and partition walls 241 disposed inside the outer peripheral wall 240, the partition walls 241 defining a plurality of cells 241a each extending from one end face to the other end face to form a flow path; and an induction heating coil 21 disposed around an outer periphery of the honeycomb structure 20, wherein at least one of the one or more honeycomb structure portions 24 contains at least one conductor and/or magnetic material 25.

### TECHNICAL FIELD

The present invention relates to a gas pyrolysis unit and a gas pyrolysis apparatus for pyrolyzing a gas.

### BACKGROUND ART

As a measure against global warming, attention is being focused on H₂ production technologies that produce H₂, a carbon-free energy source, inexpensively and in large quantities while emitting no CO₂.

While water electrolysis is one H₂ production technology that does not emit CO₂, its high cost remains a challenge. One alternative technology to water electrolysis is the thermal cracking of hydrocarbons, particularly natural gas or methane. Carbon produced by methane cracking can suppress CO₂ emissions by being recovered as a solid. On the other hand, the carbon produced as a solid, particularly for methods that use a catalyst to promote cracking, poses the challenge that the generated carbon covers the catalyst in a short period of time, causing deactivation. Therefore, it is required to be efficiently discharged out of the reactor. As for methane heating methods, a method involving external heating of the reactor where cracking takes place is considered, however, problems remain in ensuring that the entire interior of the reactor reaches the cracking temperature rapidly and in ensuring that the cracking of the gas within the reactor proceeds uniformly.

Patent Literature 1 below proposes a system for cracking hydrocarbons, such as natural gas or methane, into hydrogen and carbon using a reactor including a bed of particles consisting of electrically conductive carbon, graphite, or the like, and an induction unit for heating the bed of particles.

### CITATION LIST

### Patent Literature

[Patent Literature 1] EP 4 126 757 A1

### SUMMARY OF INVENTION

### Technical Problem

The system proposed in Patent Literature 1 may enable efficient heating because it promotes the cracking of hydrocarbons by inductively heating electrically conductive carbon and graphite within the reactor, rather than relying on external heating. However, since the relationship between the hydrocarbons fed as gas into the reactor and the electrically conductive carbon acting as a heat-generating element is not necessarily constant, achieving uniform heating may be difficult in some cases.

The present invention has been made to solve the above problems, and one of the objects is to provide a gas pyrolysis unit and a gas pyrolysis apparatus capable of heating a gas more uniformly and improving an efficiency of gas pyrolysis.

### Solution to Problem

Aspect 1. In one embodiment, the present invention relates to a gas pyrolysis unit for pyrolyzing a gas, the gas pyrolysis unit comprising: a honeycomb structure having one or more honeycomb structure portions, each of the one or more honeycomb structure portions having an outer peripheral wall and partition walls disposed on an inner side of the outer peripheral wall, the partition walls defining a plurality of cells each extending from one end face to the other end face to form a flow path; and an induction heating coil disposed around an outer periphery of the honeycomb structure, wherein at least one of the one or more honeycomb structure portions comprises at least one conductor and/or magnetic material.

Aspect 2. The present invention may relate to the gas pyrolysis unit according to Aspect 1, wherein the conductor and/or magnetic material are present in at least a part of radial and axial directions within the honeycomb structure.

Aspect 3. The present invention may relate to the gas pyrolysis unit according to Aspect 2, wherein the conductor and/or magnetic material are present inside the outer peripheral wall, inside the partition walls, inside the cells, and/or on the outer peripheral wall.

Aspect 4. The present invention may relate to the gas pyrolysis unit according to Aspect 3, wherein the conductor and/or magnetic material present inside the cells are either filled into the cells or coated on surfaces of the partition walls.

Aspect 5. The present invention may relate to the gas pyrolysis unit according to any one of Aspects 1 to 4, further comprising a magnetic shield disposed around an outer periphery of the induction heating coil.

Aspect 6. The present invention may relate to the gas pyrolysis unit according to any one of Aspects 1 to 5, wherein the honeycomb structure portion comprises at least one selected from the group consisting of cordierite, silicon carbide, silicon, silicic acid, and alumina.

Aspect 7. The present invention may relate to the gas pyrolysis unit according to any one of Aspects 1 to 6, wherein a glass or crystalline body containing Al and/or Si is disposed between the honeycomb structure and the induction heating coil.

Aspect 8. The present invention may relate to the gas pyrolysis unit according to Aspect 5, wherein a glass or crystalline body containing Al and/or Si is disposed between the induction heating coil and the magnetic shield.

Aspect 9. The present invention may relate to the gas pyrolysis unit according to any one of Aspects 1 to 8, wherein the conductor and/or magnetic material comprise at least one selected from the group consisting of Fe, Cr, Ni, Mn, Zn, Co, Cu, and Si.

Aspect 10. The present invention may relate to the gas pyrolysis unit according to any one of Aspects 1 to 9, wherein the magnetic material has a Curie point of 300 °C or more.

Aspect 11. The present invention may relate to the gas pyrolysis unit according to any one of Aspects 1 to 10, wherein at least one of the one or more honeycomb structure portions comprises a catalyst.

Aspect 12. In one embodiment, the present invention relates to a gas pyrolysis apparatus comprising the gas pyrolysis unit according to any one of Aspects 1 to 11 and a power supply circuit connected to the induction heating coil, the gas pyrolysis apparatus being configured such that the honeycomb structure can be induction-heated by magnetic flux from the induction heating coil when a gas is passed through the cells.

Aspect 13. The present invention may relate to the gas pyrolysis apparatus according to Aspect 12, wherein the gas is a gas containing hydrogen as an atom, and the gas pyrolysis apparatus is configured to obtain hydrogen by pyrolyzing the gas using the gas pyrolysis unit.

Aspect 14. The present invention may relate to the gas pyrolysis apparatus according to Aspect 13, wherein the gas comprises one or more of hydrocarbons including naphtha, hydroxides, ammonia, oxynitrides, hydrogen sulfide, and/or biogas.

### Advantageous Effects of Invention

According to an embodiment of the gas pyrolysis unit and gas pyrolysis apparatus of the present invention, at least one of the one or more honeycomb structure portions includes a conductor and/or a magnetic material, so that the spatial relationship between the conductor and/or magnetic material as a heat-generating element and the gas can be managed more reliably, the gas can be heated more uniformly, and the efficiency of gas pyrolysis can be improved.

### BRIEF DESCRIPTION OF DRAWINGS

FIG. 1 is an explanatory view showing a gas pyrolysis apparatus 1 according to Embodiment 1 of the present invention.

FIG. 2 is a perspective view showing the gas pyrolysis unit 2 in FIG. 1.

FIG. 3 is a circuit diagram showing the power supply circuit 3 in FIG. 1.

FIG. 4 is a front view showing a honeycomb structure 20 in FIG. 2 and its surroundings.

FIG. 5 is an explanatory view showing a first example of a manner in which conductors and/or magnetic materials 25 are present in the honeycomb structure 20 in FIG. 2.

FIG. 6 is an explanatory view showing a second example of a manner in which conductors and/or magnetic materials 25 are present in the honeycomb structure 20 in FIG. 2.

FIG. 7 is an explanatory view showing a third example of a manner in which conductors and/or magnetic materials 25 are present in the honeycomb structure 20 in FIG. 2.

FIG. 8 is an explanatory view showing a variation of the gas pyrolysis apparatus 1 in FIG. 1.

FIG. 9 is an explanatory view showing an example of a manner in which conductors and/or magnetic materials 25 are present in the honeycomb structure 20 in FIG. 8.

FIG. 10 is an explanatory view showing another example of a manner in which conductors and/or magnetic materials 25 are present in the honeycomb structure 20 in FIG. 8.

FIG. 11 is an explanatory view showing a gas pyrolysis apparatus 1 according to Embodiment 2 of the present invention.

### DESCRIPTION OF EMBODIMENTS

Hereinafter, embodiments of the invention will be specifically described with reference to the drawings. The invention is not limited to each embodiment, and components can be modified and embodied without departing from the spirit of the invention. Further, various inventions can be formed by appropriately combining a plurality of components disclosed in each embodiment. For example, some components may be removed from all of the components shown in the embodiments. Furthermore, the components of different embodiments may be optionally combined.

### Embodiment 1

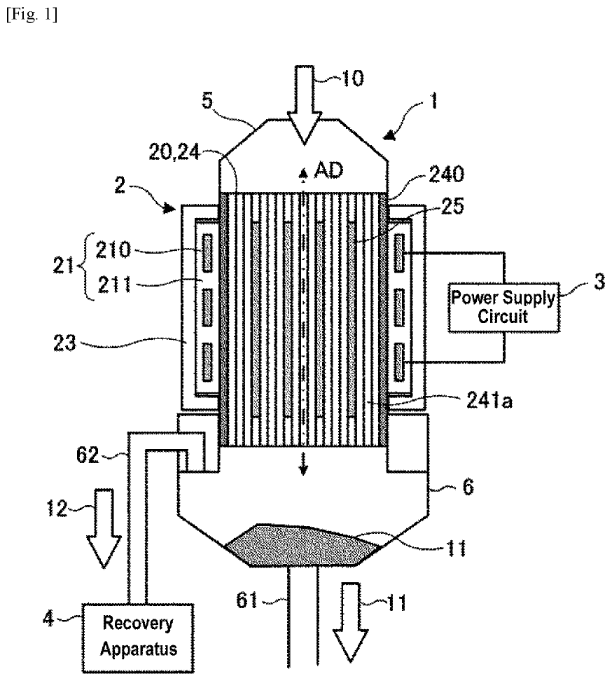

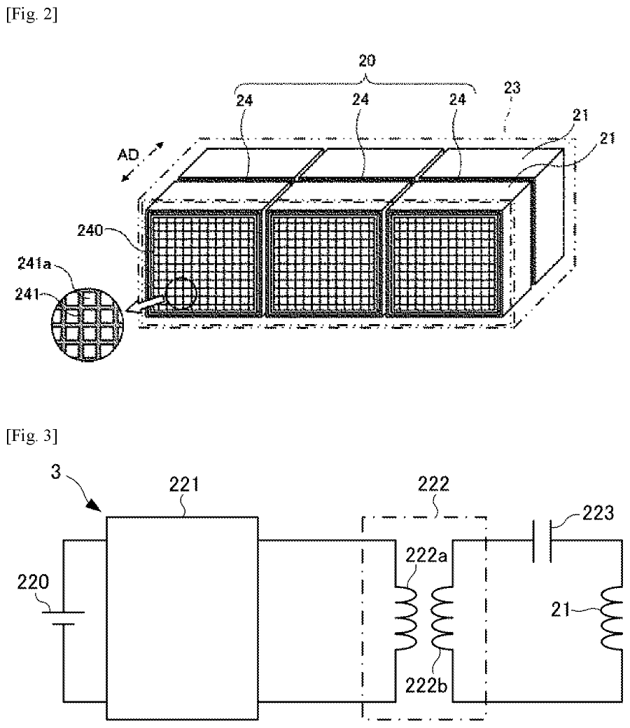

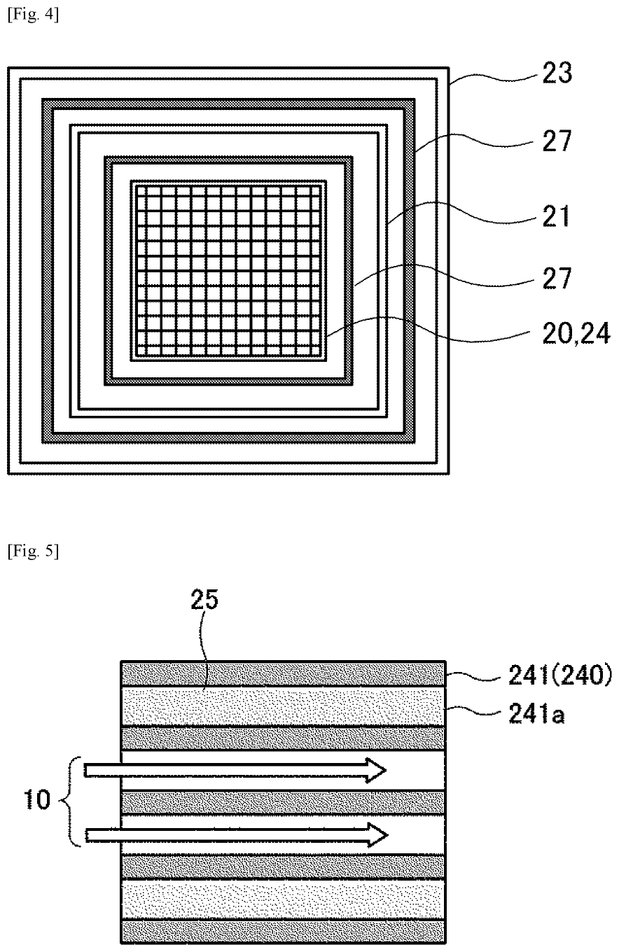

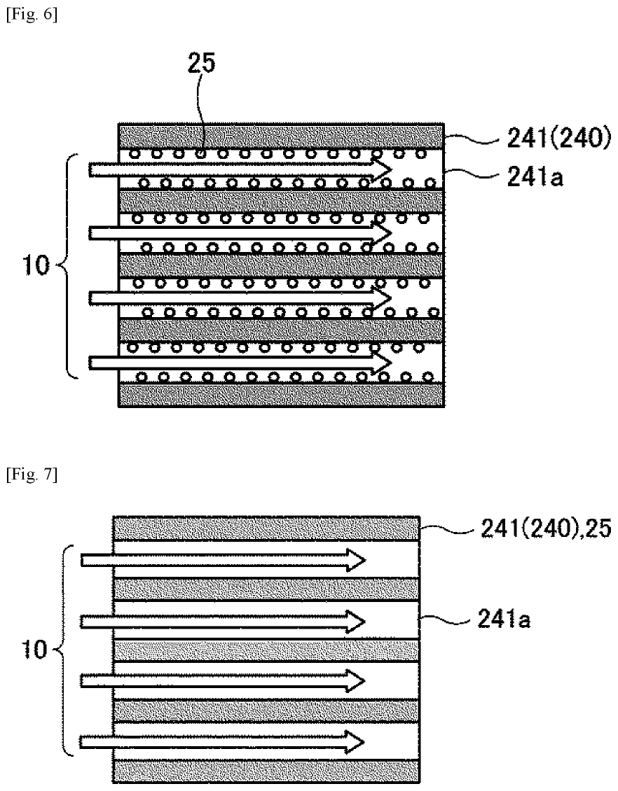

FIG. 1 is an explanatory view showing a gas pyrolysis apparatus 1 according to Embodiment 1 of the present invention, FIG. 2 is a perspective view showing a gas pyrolysis unit 2 in FIG. 1, FIG. 3 is a circuit diagram showing a power supply circuit 3 in FIG. 1, and FIG. 4 is a front view showing a honeycomb structure 20 in FIG. 2 and its surroundings. Furthermore, FIG. 5 is an explanatory view showing a first example of a manner in which conductors and/or magnetic materials 25 are present in the honeycomb structure 20 in FIG. 2, FIG. 6 is an explanatory view showing a second example of a manner in which conductors and/or magnetic materials 25 are present in the honeycomb structure 20 in FIG. 2, and FIG. 7 is an explanatory view showing a third example of a manner in which conductors and/or magnetic materials 25 are present in the honeycomb structure 20 in FIG. 2.

The gas pyrolysis apparatus 1 and the gas pyrolysis unit 2 shown in FIGS. 1 and 2 are an apparatus and a unit for pyrolyzing a gas 10. The gas 10 is a gas containing hydrogen as an atom, and the gas pyrolysis apparatus 1 is configured to obtain hydrogen by pyrolyzing the gas 10 using the gas pyrolysis unit 2. The hydrogen obtained in the gas pyrolysis apparatus 1 is discharged from the gas pyrolysis apparatus 1 and recovered in a recovery apparatus 4. Examples of the recovery apparatus 4 include a hydrogen recovery system equipped with a purification mechanism as necessary.

A gas containing hydrogen as an atom refers to a gas whose component chemical formula includes hydrogen (H). Such a gas may contain one or more of hydrocarbons, hydroxides, ammonia, oxynitrides, hydrogen sulfide, and/or biogas. Hydrocarbons include, for example, naphtha. FIG. 1 illustrates, as an example, a gas pyrolysis apparatus 1 into which methane (CH₄) is introduced as a gas 10 and methane is pyrolyzed into hydrogen and carbon 11 (CH₄→C (solid)+2H₂). A mixed gas 12 of hydrogen and methane is recovered in the recovery apparatus 4. In the recovery apparatus 4, high-purity hydrogen can be generated or recovered using PSA (pressure swing adsorption) or a hydrogen separation membrane, or the like.

As shown in FIG. 1, the gas pyrolysis apparatus 1 includes the gas pyrolysis unit 2, a power supply circuit 3, a first chamber 5, and a second chamber 6.

The gas pyrolysis unit 2 is for pyrolyzing the gas as described above. The gas pyrolysis unit 2 includes a honeycomb structure 20 and an induction heating coil 21.

The honeycomb structure 20 has one or more honeycomb structure portions 24. FIG. 2 shows a honeycomb structure 20 having the plurality of honeycomb structure portions 24. As illustrated in FIG. 2, the honeycomb structure portion 24 has an outer peripheral wall 240 and partition walls 241 provided on an inner side of the outer peripheral wall 240, the partition walls 251 defining a plurality of cells 241a, each of the cells 241a extending from one end face to other end face of the honeycomb structure portion 24 to form a flow path. The outer shape of the honeycomb structure 24 may be pillar-shaped. The pillar shape is understandable as a three-dimensional shape having a given thickness in an axial direction AD. The axial direction AD can be the extending direction of the cells 241a. A ratio of the axial length of the honeycomb structure portion 24 to the diameter or width of the end face of the honeycomb structure 24 (aspect ratio) is arbitrary. The pillar shape may include a shape (flat shape) in which the axial length of the honeycomb structure portion 24 is shorter than the diameter or width of the end face. The outer shape of the honeycomb structure portion 24 can include, but not limited to, a pillar shape with quadrangular end faces (quadrangular pillar shape), a pillar shape with circular or oval end faces, a pillar shape with polygonal end faces (triangular, pentagonal, hexagonal, heptagonal, octagonal, etc.) with less or more corners on the end faces, as shown in FIG. 2.

The material of the honeycomb structure portion 24 (the outer peripheral wall 240 and the partition walls 241) is not particularly limited, but it is typically made of a ceramic material. The honeycomb structure portion 24 preferably includes at least one selected from the group consisting of cordierite, silicon carbide, silicon, silica, and alumina. Specific examples of the honeycomb structure include cordierite, silicon carbide, aluminum titanate, silicon nitride, mullite, alumina, silica, silicon-silicon carbide-based composite materials, silicon carbide-cordierite-based composite materials, and the like. More preferably, it is formed of cordierite, alumina, silica, silicon carbide, and silicon-silicon carbide-based composite material. As used herein, the term “silicon carbide-based” or “cordierite-based” means that the outer peripheral wall 240 and the partition walls 241 contain silicon carbide or cordierite in an amount of 50% by mass or more of the whole of the outer peripheral wall 240 and the partition walls 241.

The shape of each cell 241a is not particularly limited, but it may be polygonal such as triangular, quadrangular, pentagonal, hexagonal, heptagonal, and octagonal, circular, or oval in the cross section of the honeycomb structure 20 orthogonal to the central axial direction. Preferably, it may be polygonal.

The thickness of the partition walls 241 may preferably be 0.05 to 0.50 mm, and more preferably 0.07 to 0.38 mm in terms of ease of production. For example, the thickness of the partition walls 251 of 0.05 mm or more improves the strength of the honeycomb structure 20, and the thickness of 0.50 mm or less reduces the pressure loss. The thickness of the partition walls 241 is an average value measured by the method of microscopic observation of the cross-section in the central axial direction.

The porosity of the partition walls 241 is preferably 20 to 70%. The porosity of the partition walls 241 is preferably 20% or more in terms of ease of production, and when it is 70% or less, the strength of the honeycomb structure 20 can be maintained.

The partition walls 241 preferably has an average pore size of 2 to 30 μm, and more preferably 5 to 25 μm. The average pore diameter of the partition walls 241 of 2 μm or more may lead to easy production, and the average pore diameter of 30 μm or less can ensure the strength of the honeycomb structure 20. As used herein, the terms “average pore size” and “porosity” refer to the average pore size and porosity measured by mercury intrusion technique.

The cells 241a preferably has a density in the range of 5 to 150 cells/cm², more preferably in the range of 16 to 100 cells/cm², and even more preferably in the range of 31 to 100 cells/cm², although not particularly limited thereto.

Such a honeycomb structure portion 24 is produced by forming a green body containing ceramic raw materials into a honeycomb shape having partition walls 241 that extend from one end face to the other end face and define a plurality of cells 241a as fluid flow paths to form a honeycomb formed body, and then drying and firing the honeycomb formed body. The outer peripheral wall 240 may be an outer peripheral wall 240 extruded integrally with the honeycomb formed body, or after the honeycomb formed body is formed or fired, the outer periphery of the honeycomb formed body or honeycomb sintered body is ground to a predetermined shape, and a coating material is applied to the honeycomb formed body or honeycomb sintered body whose outer periphery has been ground to form an outer peripheral coating, which may be used as the outer peripheral wall 240 (in this case, only the outer peripheral coating becomes the peripheral wall 240). Also, without being ground the outer peripheral wall 240 extruded integrally with the honeycomb formed body, an outer peripheral coating may be formed on the outer peripheral wall 240 (the outer peripheral wall 250 has a two layer structure of the outer peripheral wall such as the honeycomb sintered body and the outer peripheral coating).

The honeycomb structure 20 is not limited to the integral honeycomb structure 20 in which the partition walls 241 are integrally formed, and it may be, for example, a honeycomb structure 20 (joined honeycomb structure) having a structure in which a plurality of pillar shaped honeycomb segments, each having a plurality of cells 241a as fluid flow paths defined by ceramic partition walls 241 are combined together via joining material layers.

At least one of the one or more honeycomb structure portions 24 according to this embodiment contains at least one conductor and/or magnetic material 25. The gas pyrolysis apparatus 1 according to this embodiment is configured such that the honeycomb structure 20 can be induction-heated by magnetic flux from the induction heating coil 21 when the gas is passed through the cells 241a.

Here, to efficiently pyrolyze the gas, it is preferable to heat the gas uniformly. As in Patent Literature 1 described above, simply placing a heating element inside the reactor may make uniform heating difficult because the spatial relationship between the gas and the heating element within the reactor is not necessarily constant. However, by incorporating the conductors and/or magnetic materials 25 into a structure having a predetermined shape, such as the honeycomb structure portion 24, the spatial relationship between the gas and the conductors and/or magnetic materials 25 within the honeycomb structure portion 24 can be managed more reliably, the gas can be heated more uniformly, and the efficiency of gas pyrolysis can be improved.

Furthermore, the incorporation of the conductors and/or magnetic materials 25 into the honeycomb structure portion 24 allows the effective surface area for pyrolysis per unit volume to be increased. Additionally, flow paths (cells 241a) for the gas can be ensured within the honeycomb structure 20, enabling efficient pyrolysis of the gas and improving the recovery efficiency of the pyrolyzed gas.

As will be described later with reference to the drawings, the conductors and/or magnetic materials 25 may be present in at least a part of radial and axial directions AD within the honeycomb structure 20. Furthermore, the conductors and/or magnetic materials 25 may be present inside the outer peripheral wall 240, inside the partition walls 241, inside the cells 241a, and/or on the outer peripheral wall 240. The conductors and/or magnetic materials 25 present inside the cells 241a may be filled into the cells 241a or coated on surfaces of the partition walls 241.

FIG. 5 illustrates a configuration in which the conductors and/or magnetic materials 25 are filled into some of the cells 241a. The conductor and/or magnetic material 25 may have a pillar-shaped outer shape conforming to the shape of the cells 241a. The conductor and/or magnetic material 25 may have such a shape prior to being filled into the cells 241a, or may acquire such a shape upon being filled into the cells 241a. In other words, the conductor and/or magnetic material 25 may form a shaped material having a predetermined shape, or may form an amorphous material in a paste form.

The shaped material and the amorphous material may be composed of a composite comprising the conductor and/or magnetic material 25 and a bonding material or adhesive material. The binding material includes, for example, materials based on a metal or glass. The adhesive material includes materials based on silica or alumina. In addition to the binding material or adhesive material, it may further contain organic or inorganic materials. The conductors and/or magnetic materials 25 may be filled throughout the entire length of the honeycomb structure 20, from one end face to the other end face. Alternatively, the conductors and/or magnetic materials 25 may be filled from one end face of the honeycomb structure 20 to the midpoint of the cells 241a.

The conductors and/or magnetic materials 25 are induction-heated by the magnetic flux from the induction heating coil 21, and the honeycomb structure portion 24 is heated by that heat. By filling the conductors and/or magnetic materials 25 into some of the cells 241a, it becomes possible to cause the cells 241a to function as heaters within the honeycomb structure 20.

FIG. 6 illustrates a configuration in which the conductors and/or magnetic materials 25 are coated on surfaces of the partition walls 241. Although the illustrated configuration shows the conductors and/or magnetic materials 25 coated on the surfaces of the partition walls 241 of all the cells 241a, the conductors and/or magnetic materials 25 may be coated only on the surfaces of the partition walls 241 of some of the cells 241a.

The conductors and/or magnetic materials 25 coated on the surfaces of the partition walls 241 may form a coating layer together with a fixing agent in which the conductors and/or magnetic materials 25 are dispersed. The fixing agent that can be used herein includes glass which contains silicic acid, boric acid or borosilicate, crystallized glass, ceramics, or glass, crystallized glass, ceramics, including other oxides, or the like. The conductors and/or magnetic materials 25 may extend from one end face of the honeycomb structure portion 24 to the other end face, or may extend only over a portion in the axial direction AD. The amount of the conductors and/or magnetic materials 25 contained in the coating layer may be varied with respect to the radial and axial directions AD within the honeycomb structure 20.

The conductors and/or magnetic materials 25 are induction-heated by the magnetic flux from the induction heating coil 21, and the honeycomb structure portion 24 is heated by that heat. Because the conductors and/or magnetic materials 25 are coated on the surfaces of the partition walls 241, it becomes possible to cause the cells 241a to function as heaters within the honeycomb structure 20, in the same manner as the case where the conductors and/or magnetic materials 25 are filled into the cells 241a. On the other hand, the gas 10 can also pass through the interior of the cells 241a even when the surfaces of the partition walls 241 are coated with the conductors and/or magnetic materials 25, and in the configuration where the conductors and/or magnetic materials 25 are coated on the surfaces, the flow resistance of the gas 10 can be reduced as compared to the configuration where the conductors and/or magnetic materials 25 are filled into the cells 241a.

FIG. 7 illustrates a configuration in which conductors and/or magnetic materials 25 are present inside the outer peripheral wall 240 and the partition walls 241. The honeycomb structure portion 24 (the outer peripheral wall 240 and the partition walls 241) is typically made of a ceramic material such as cordierite. By producing the honeycomb structural portion 24 with the conductors and/or magnetic materials 25 mixed into or coated onto the ceramic material, the conductors and/or magnetic materials 25 can be incorporated into the interior of the outer peripheral wall 240 and the partition walls 241. By adopting such an embodiment, it will be possible to allows the outer peripheral wall 240 and the partition walls 241 to function as heaters in the honeycomb structure 20. The manners in which the conductors and/or magnetic materials 25 are present may be optionally combined.

The conductor and/or magnetic material 25 may contain at least one selected from the group consisting of Fe, Cr, Ni, Mn, Zn, Co, Cu, and Si. Examples of the conductors and/or magnetic materials 25 include metals such as balance Co—20 mass % Fe, balance Co—25 mass % Ni—4 mass % Fe, balance Fe—15 to 35 mass % Co, balance Fe—17 mass % Co—2 mass % Cr—1 mass % Mo, balance Fe—49 mass % Co—2 mass % V, balance Fe—18 mass % Co—10 mass % Cr—2 mass % Mo—1 mass % Al, balance Fe—27 mass % Co—1 mass % Nb, balance Fe—20 mass % Co—1 mass % Cr—2 mass % V, balance Fe—35 mass % Co—1 mass % Cr, pure cobalt, pure iron, electromagnetic soft iron, balance Fe—0.1 to 0.5 mass % Mn, balance Fe—3 mass % Si, balance Fe—6.5 mass % Si, balance Fe—18 mass % Cr, balance Fe—16 mass % Cr—8 mass % Al, balance Ni—13 mass % Fe—5.3 mass % Mo, balance Fe—45 mass % Ni, balance Fe—10 mass % Si—5 mass % Al, balance Fe—36 mass % Ni, balance Fe—45 mass % Ni, balance Fe—35 mass % Cr, balance Fe—13 mass % Cr—2 mass % Si, balance Fe—20 mass % Cr—2 mass % Si—2 mass % Mo, balance Fe—20 mass % Co—1 mass % V, balance Fe—13 mass % Cr—2 mass % Si, and balance Fe—17 mass % Co—2 mass % Cr—1 mass % Mo. Furthermore, examples the conductor and/or magnetic material 25 also include oxides such as Mn—Zn ferrite, Cu—Zn ferrite, Ni—Zn ferrite, and Cu—Zn—Mg ferrite. These conductors and/or magnetic materials 25 have Curie points that differ depending on the substance and are appropriately selected according to the heating temperature required for the pyrolysis of the gas.

At least one of the one or more honeycomb structure portions 24 may contain a catalyst. Examples of catalysts include Ni, Fe, and Ru, and the like, for the purpose of lowering the decomposition temperature. The catalyst is provided on the wall surfaces of the cells 241a so as to come into contact with the gas 10. The catalyst may be provided in cells other than the cells 241a containing the conductors and/or magnetic materials 25, or may be provided so as to coexist in the same cells 241a as the conductors and/or magnetic materials 25. The provision of the catalyst in the separate cells 241a allows the effects of chemical reactions and the like to be suppressed between the catalyst and the conductors and/or magnetic materials 25. On the other hand, the provision of the catalyst and the conductors and/or magnetic materials 25 in the same cells 241a allows them to be brought into contact with each other, and direct transferring of heat from the conductors and/or magnetic materials 25 to the catalyst allows the catalyst to be more efficiently heated to reach the required temperature.

The induction heating coil 21 is disposed on the outer periphery of the honeycomb structure 20. The induction heating coil 21 may be a conductor 210 wound around a predetermined axis. The axis of the induction heating coil 21 can be parallel to the axial direction AD of the honeycomb structure 20. The axis may be coaxial with the central axis of the honeycomb structure 20. Although FIG. 1 illustrates the conductor 210 in the form of a strip having a rectangular cross section, the conductor 210 may have any shape and may have other shapes, such as a circular or tubular shape. The conductor 210 may be molded with an insulating material 211. Materials such as alumina, aluminum silicate, mullite, silica, and/or heat-resistant resins may be used as the insulating material 211. FIG. 1 illustrates an embodiment in which the conductor 210 molded with the insulating material 211 is fitted to the outer surface of an outer peripheral wall 240 of the honeycomb structure 20.

A power supply circuit 3 is connected to the induction heating coil 21. As illustrated in FIG. 3, the power supply circuit 3 can include a DC power supply 220, an inverter 221, a transformer 222, and a resonance capacitor 223. DC power from the DC power supply 220 is converted into AC power by the inverter 221. The transformer 222 is used when it is desired to amplify the current flowing through the induction heating coil 21, and has a primary coil 222a connected to the inverter 221, and a secondary coil 222b connected to the resonant capacitor 223 and the induction heating coil 21. The turns ratio of the primary coil 222a and the secondary coil 222b is N:1. N is a number greater than 1, the transformer 222 can amplify the current of AC power. The capacitance of the resonance capacitor 223 is set so as to adjust the resonance frequency of the power supply circuit 3. The induction heating coil 21 can be connected in series to the resonance capacitor 223 and can be connected together with the resonance capacitor 223 to both ends of the secondary coil 222b. When the power supply is AC, there is no need to convert it to AC current, and therefore, a high-frequency converter can be used in place of the inverter. Although the frequency used for the AC current is not specified, frequencies in the range of 10 to 400 kHz, preferably 30 to 100 kHz, are suitably employed.

When an alternating current is supplied from the power supply circuit 3 to the induction heating coil 21, a magnetic flux is generated in the vicinity of the induction heating coil 21. The honeycomb structure 20 and the conductors and/or magnetic materials 25 can be induction-heated by the magnetic flux from the induction heating coil 21.

By selecting the Curie point of the conductors and/or magnetic materials 25, the heating temperature of the conductors and/or magnetic materials 25 due to induction heating can be adjusted. Although the conductors and/or magnetic materials 25 are heated for the purpose of pyrolyzing the gas, an excessively high temperature may cause problems that reactions other than the intended pyrolysis reaction occur, the reaction rates of exothermic or endothermic reactions become too fast, the catalyst used to promote decomposition is deteriorated, and so on. By selecting the conductors and/or magnetic materials 25 each having a low Curie point, the occurrence of such problems can be suppressed. The conductors and/or magnetic materials 25 may have a Curie point of 300 °C or higher. It is preferable that the Curie point of the conductors and/or magnetic materials 25 be 500 °C or higher, and more preferably 700 °C or higher.

The gas pyrolysis unit 2 may further include a magnetic shield 23 disposed around the outer periphery of the induction heating coil 21. The magnetic shield 23 may be disposed to surround the induction heating coil 21. The magnetic shield 23 may be made of a magnetic material. In the illustrated embodiment, the magnetic shield 23 is configured as a tubular member disposed around the outer circumference of the induction heating coil 21 and having walls that protrude radially inward at both ends. The length of the magnetic shield 23 in the axial direction of the induction heating coil 21 may be longer than the length of the induction heating coil 21 in the same direction. The provision of such a magnetic shield 23 suppresses the leakage of magnetic flux to the outside, thereby enabling more efficient heating of the honeycomb structure.

As shown in FIG. 4, a glass or crystal body 27 containing Al and/or Si may be placed between the honeycomb structure 20 and the induction heating coil 21. The glass or crystal body 27 containing Al and/or Si may also be placed between the induction heating coil 21 and the magnetic shield 23. By placing the glass or crystal body 27 containing Al and/or Si (hereinafter simply referred to as “crystal body 27”) at these positions, electrical short circuits among the honeycomb structure 20, the induction heating coil 21, and the magnetic shield 23 can be prevented, and components such as moisture contained in the gas flowing through the honeycomb structure 20 can be prevented from coming into contact with the induction heating coil 21. Although FIG. 4 illustrates the crystal body 27 as a frame having a rectangular cross section that surrounds the honeycomb structure 20 and the like, the crystal body 27 may have other shapes. For example, the crystal body 27 may be a plate-shaped body that is laminated on only one side of the honeycomb structure 20 or the like. FIG. 4 illustrated the enlarged gap between the honeycomb structure 20 and the induction heating coil 21, but it is merely for ease of understanding.

The honeycomb structure 20 may have only a single honeycomb structure portion 24, but as shown in FIG. 2, it may also have a plurality of honeycomb structure portions 24. FIG. 2 illustrates an arrangement in which three rectangular parallelepiped honeycomb structure portions 24, each extending lengthwise in the axial direction AD (the flow direction of the gas), are arranged in parallel. Each of the honeycomb structure portions 24 is provided with two induction heating coils 21, and also provided with a single magnetic shield 23 to surround the entire set of the three honeycomb structure portions 24. The two induction heating coils 21 are disposed at the front and rear ends of the honeycomb structure portions 24 in the axial direction AD.

One of the one or more honeycomb structure portions 24 arranged in parallel is referred to as a first honeycomb structure portion, and the one arranged adjacent to the first honeycomb structure portion is referred to as a second honeycomb structure portion. When the first honeycomb structure portion has the conductors and/or magnetic materials 25 as described above, the second honeycomb structure portion may not have the conductors and/or magnetic materials 25. This is because the second honeycomb structure portion can be heated by the heat generated in the first honeycomb structure portion. The second honeycomb structure portions that do not have the conductors and/or magnetic materials 25 may be disposed on both sides of the first honeycomb structure portion that has the conductors and/or the magnetic materials 25, or the first honeycomb structure portions that have the conductors and/or magnetic materials 25 may be disposed on both sides of the second honeycomb structure portion that does not have the conductors and/or magnetic materials 25. The configuration of the second honeycomb structure portion may be the same as that of the honeycomb structure portion 24 described above, with the exception that it does not have the conductors and/or magnetic materials 25.

Furthermore, a plurality of honeycomb structure portions 24 may be arranged in series in the axial direction AD. One of the plurality of honeycomb structure portions 24 arranged in series is referred to as an upstream honeycomb structure portion, and the one arranged downstream of the upstream honeycomb structure portion in the flow direction of the gas is referred to as a downstream honeycomb structure portion. When the upstream honeycomb structure portion has the conductors and/or magnetic materials 25 as described above, the downstream honeycomb structure portion may not have the conductors and/or magnetic materials 25. This is because the downstream honeycomb structure portion can be heated by the heat generated in the upstream honeycomb structure portion. The configuration of the downstream honeycomb structure portion may be the same as that of the honeycomb structure portion 24 described above, with the exception that it does not have the conductors and/or magnetic materials 25.

As shown in FIG. 1, the first chamber 5 is disposed at one end of the honeycomb structure 20 in the axial direction AD. The first chamber 5 forms an internal space communicating with one end face of the honeycomb structure 20. The inner wall of the first chamber 5 may cover the entire outer surface of the outer peripheral wall 240, may cover only a portion of the outer surface, or may not cover the entire outer surface. When the inner wall of the first chamber 5 covers the entire outer surface of the outer peripheral wall 240, the leading end of the first chamber 5 (the lower end shown in the figure) may be positioned at the end face of the opposite end of the honeycomb structure 20, or it may be positioned beyond the end face of the opposite end of the honeycomb structure 20 in the axial direction AD. Furthermore, when the inner wall of the first chamber 5 covers the entire outer surface of the outer peripheral wall 240, the induction heating coil 21 may be positioned outside the first chamber 5. The inner wall of the first chamber 5 covers at least a portion of the outer peripheral wall 240, so that leakage of the gas 10 from the interior of the first chamber 5 to the outside of the outer peripheral wall 240 can be suppressed, thereby improving gas sealing performance. The second chamber 6 is disposed at the other end of the honeycomb structure 20 in the axial direction AD. The second chamber 6 forms an internal space communicating with the other end face of the honeycomb structure 20.

The gas 10 may be introduced from the first chamber 5 into the honeycomb structure 20. The honeycomb structure 20 may be disposed such that the axial direction AD aligns with the vertical direction. The first chamber 5 may be referred to as an upstream chamber or upper chamber, and the second chamber 6 may be referred to as a downstream chamber or lower chamber.

The gas 10 from the first chamber 5 enters the cells 241a from one end face of the honeycomb structure 20, passes through the cells 241a, and exits the honeycomb structure 20 from the other end face. As the gas 10 passes through the cells 241a, it is pyrolyzed. When methane (CH₄) is used as the gas 10 as described above, the generated carbon 11 is accumulated in the second chamber 6. The carbon 11 can be recovered through a first passage 61 connected to the lower portion of the second chamber 6. Furthermore, a mixed gas 12 of hydrogen and methane is accumulated in the internal space of the second chamber 6. The mixed gas 12 can be recovered through a second passage 62 connected to the upper portion of the second chamber 6. The mixed gas 12 is sent to the recovery apparatus 4, which can purify or recover high-purity hydrogen.

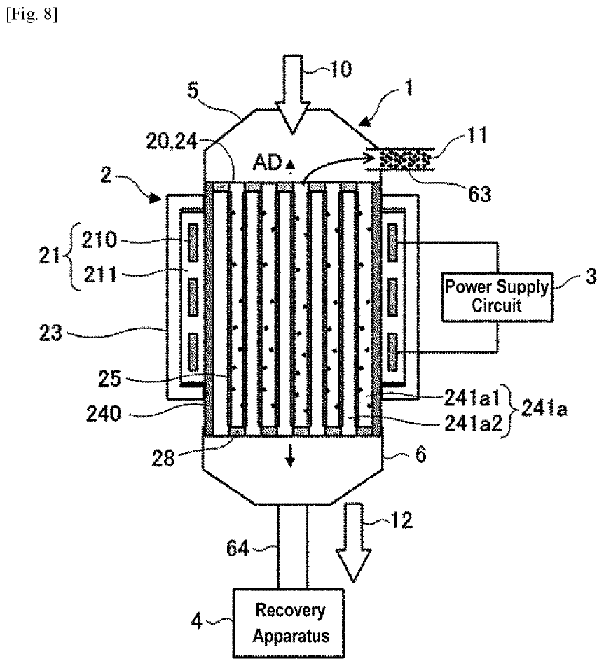

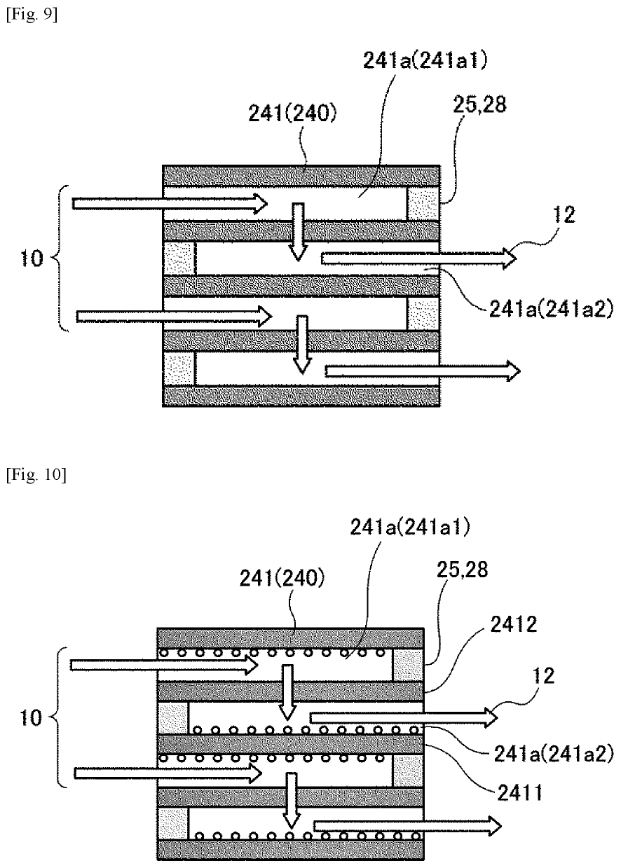

Next, FIG. 8 is an explanatory view showing a variation of the gas pyrolysis apparatus 1 in FIG. 1, FIG. 9 is an explanatory view showing one example of a manner in which conductors and/or magnetic materials 25 are present in the honeycomb structure 20 in FIG. 8, and FIG. 10 is an explanatory view showing another example of a manner in which conductors and/or magnetic materials 25 are present in the honeycomb structure 20 in FIG. 8. As the honeycomb structure 20 or honeycomb structure portion 24, a honeycomb filter may be used in which plugged portions 28 are formed at the ends of the cells 241a. The cells 241a include first cells 241a1 plugged at the other end face, and second cells 241a2 plugged at one end face.

FIG. 8 illustrates a configuration in which the conductors and/or magnetic materials 25 are coated on the surfaces of the partition walls 241, as described with reference to FIG. 6. In this case, the plugged portion 28 may be formed from a ceramic material such as cordierite, similar to the honeycomb structure portion 24 (outer peripheral wall 240 and partition walls 241). As described with reference to FIGS. 5 and 7, the conductors and/or magnetic materials 25 may also be present.

Furthermore, as shown in FIG. 9, the plugged portions 28 may be formed by the conductors and/or magnetic materials 25 filled into the cells 241a.

Furthermore, as shown in FIG. 10, first partition walls 2411 coated with the conductors and/or magnetic materials 25 and second partition walls 2412 that are not coated with the conductors and/or magnetic materials 25 may be provided. The second partition wall 2412 may be positioned between the first cell 241a1 and the second cell 241a2, and the first partition wall 2411 and the second partition wall 2412 may be adjacent to each other in the width direction or the radial direction of the honeycomb structure portion 24. Providing the second partition walls 2412 can reduce the flow resistance of the gas 10. Other configurations are the same as those shown in FIG. 1. The manners in which the conductors and/or magnetic materials 25 are present may be optionally combined.

In the gas pyrolysis apparatus 1 shown in FIGS. 8 to 10, the gas 10 flowing into the first cells 241a1 from one end face passes through the partition walls 241 to reach the second cells 241a2, and flows out from the other end face through the second cells 241a2. As described above, when methane (CH₄) is used as the gas 10, the generated carbon 11 is accumulated (captured) in the first cells 241a1. A third passage 63 is connected to the first chamber 5. By backwashing the honeycomb structure 20 or the honeycomb structure portion 24, the carbon 11 within the first cells 241a1 can be recovered through the third passage 63. The mixed gas 12 of hydrogen and methane from the second cells 241a2 can be recovered through a fourth passage 64 connected to the second chamber 6. Other configurations are the same as those shown in FIG. 1.

### Embodiment 2

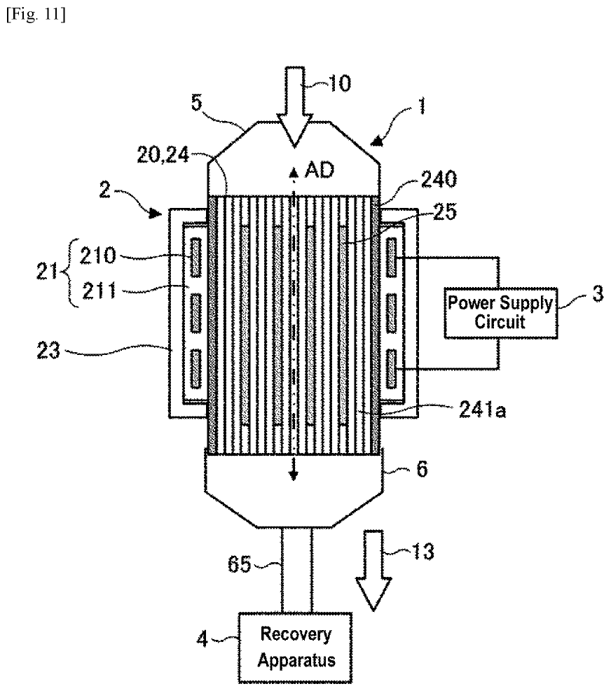

FIG. 11 is an explanatory view showing a gas pyrolysis apparatus 1 according to Embodiment 2 of the present invention. While Embodiment 1 described a configuration primarily for the pyrolysis of methane (CH₄), the gas pyrolysis apparatus 1 may be used to perform the pyrolysis of other gases 10. In Embodiment 2, ammonia (NH₃) is introduced into the gas pyrolysis apparatus 1 as the gas 10. Ammonia is pyrolyzed into hydrogen and nitrogen in the gas pyrolysis unit 2 (NH₃→0.5N₂+1.5H₂). A mixed gas 13 of hydrogen, nitrogen, and ammonia is accumulated in the internal space of the second chamber 6. The mixed gas 13 can be recovered through a fifth passage 65 connected to the lower portion of the second chamber 6. The mixed gas 13 is sent to the recovery apparatus 4, which can purify or recover high-purity hydrogen. Other configurations are the same as those in Embodiment 1.

While the preferred embodiments of the invention have been described above in detail with reference to the drawings, the present invention is not limited to such embodiments. It is obvious that a person skilled in the art to which this invention belongs can arrive at various variations or modifications in the scope of the technical idea recited in the claims, and it is understood that they also belong to the technical scope of this invention.

### DESCRIPTION OF REFERENCE NUMERALS

1 gas pyrolysis apparatus
2 gas pyrolysis unit
10 gas
20 honeycomb structure
21 induction heating coil
23 magnetic shield
24 honeycomb structure portion
240 outer peripheral wall
241 partition wall
241a cell
25 conductor and/or magnetic material
27 glass or crystal body

1. A gas pyrolysis unit for pyrolyzing a gas, the gas pyrolysis unit comprising:
a honeycomb structure having one or more honeycomb structure portions, each of the one or more honeycomb structure portions having an outer peripheral wall and partition walls disposed on an inner side of the outer peripheral wall, the partition walls defining a plurality of cells each extending from one end face to the other end face to form a flow path; and
an induction heating coil disposed around an outer periphery of the honeycomb structure,
wherein at least one of the one or more honeycomb structure portions comprises at least one conductor and/or magnetic material.

2. The gas pyrolysis unit according to claim 1, wherein the conductor and/or magnetic material are present in at least a part of radial and axial directions within the honeycomb structure.

3. The gas pyrolysis unit according to claim 2, wherein the conductor and/or magnetic material are present inside the outer peripheral wall, inside the partition walls, inside the cells, and/or on the outer peripheral wall.

4. The gas pyrolysis unit according to claim 3, wherein the conductor and/or magnetic material present inside the cells are either filled into the cells or coated on surfaces of the partition walls.

5. The gas pyrolysis unit according to claim 1, further comprising a magnetic shield disposed around an outer periphery of the induction heating coil.

6. The gas pyrolysis unit according to claim 1, wherein the honeycomb structure portion comprises at least one selected from the group consisting of cordierite, silicon carbide, silicon, silicic acid, and alumina.

7. The gas pyrolysis unit according to claim 1, wherein a glass or crystalline body containing Al and/or Si is disposed between the honeycomb structure and the induction heating coil.

8. The gas pyrolysis unit according to claim 5, wherein a glass or crystalline body containing Al and/or Si is disposed between the induction heating coil and the magnetic shield.

9. The gas pyrolysis unit according to claim 1, wherein the conductor and/or magnetic material comprise at least one selected from the group consisting of Fe, Cr, Ni, Mn, Zn, Co, Cu, and Si.

10. The gas pyrolysis unit according to claim 1, wherein the magnetic material has a Curie point of 300 °C or higher.

11. The gas pyrolysis unit according to claim 1, wherein at least one of the one or more honeycomb structure portions comprises a catalyst.

12. A gas pyrolysis apparatus comprising:
the gas pyrolysis unit according to claim 1; and
a power supply circuit connected to the induction heating coil,
wherein the gas pyrolysis apparatus is configured such that the honeycomb structure can be induction-heated by magnetic flux from the induction heating coil when the gas is passed through the cells.

13. The gas pyrolysis apparatus according to claim 12, wherein the gas is a gas containing hydrogen as an atom, and the gas pyrolysis apparatus is configured to obtain hydrogen by pyrolyzing the gas using the gas pyrolysis unit.

14. The gas pyrolysis apparatus according to claim 13, wherein the gas comprises one or more of hydrocarbons including naphtha, hydroxides, ammonia, oxynitrides, hydrogen sulfide, and/or biogas.
